(19) United States
(12) Patent Application Publication
(10) Pub. No.: US 2008/0295160 A1
(43) Pub. Date: Nov. 27, 2008

(54) Biometrically controlled personal data management system and device

(76) Inventors: Eugene Cuprin, Ashkelon (IL); Igor Donskoy, Ashkelon (IL)

Correspondence Address: Pearl Cohen Zedek Latzer, LLP, 1500 Broadway, 12th Floor, New York, NY, 10036, US

(21) Appl. No.: 11/802,120

(22) Filed: May 21, 2007

(51) Int. Cl. G06F 21/02

(52) U.S. Cl. 726/7

(57) ABSTRACT

A device and method for storing personal network access information and biometric data, and upon a match of received biometric information from a user with such stored biometric data, transmitting such personal network access information to a network.

### FIELD OF THE INVENTION

The present invention generally relates to biometric sensors and storage of network access passwords and access data. More particularly, the present invention relates to a device and method for implementing a network access procedure stored on a device upon the receipt of biometric data that matches information stored on such device.

### BACKGROUND OF THE INVENTION

Biometric sensors used to limit access to electronic devices are known. Once a user gains access to the electronic device he is then permitted to initiate a connection and log-on procedure with a network that he may desire to access.

### SUMMARY OF THE INVENTION

Some embodiments of the invention include a device having a memory to store network access information of a user, store network access procedures for gaining access to a network by the user, and store biometric information of the user, whereupon receipt of biometric data, such as data received from the biometric sensor, that matches the biometric information stored in the memory, the network access procedure may be executed from a processor in or proximate to the device and the network access information may be transmitted.

In some embodiments, a biometric sensor may include one or more of a fingerprint reader, a voice sensor, a signature reader and an iris sensor.

In some embodiments, a memory on the device may store a blocking code, to block access to the network access information, where the blocking code is deactivated by a processor on or connected to the device upon receipt of the biometric data from the biometric sensor.

In some embodiments, network access information may include information to let a user obtain access to a particular resource on a remote network, such as for example, a particular data base or property.

In some embodiments, the network access procedures may include settings for a computer to emulate a virtual private network.

In some embodiments, a processor on or connected to the device may compare biometric data received from the sensor to biometric information, may execute or implement the network access procedure from the device.

In some embodiments, the network access procedure may include authorization information for a financial transaction that may be executed or authorized from the device or from a computer to which the device is physically or wirelessly connected.

In some embodiments, the network access procedures may include a process of filling in a field in a log-on form.

In some embodiments, the memory may store a public-private key pair and a cryptograph algorithm suitable for decoding of the private key.

Some embodiments of the invention may include a method of storing in a memory personal network access information of a user, storing in the memory biometric information of the user, receiving biometric data from the user, by way of for example a biometric sensor that may be connected to or proximate to the device, and comparing the received biometric data to the stored biometric information, and transmitting the network access information of the user to a network.

In some embodiments, a method may include storing in the memory a network access procedure and activating the network access procedure following a successful comparing of the received biometric data to the stored biometric data.

In some embodiments, the receiving may include receiving biometric data from a biometric sensor such as from a fingerprint reader, a voice recognition sensor, a signature reader and an iris sensor.

In some embodiments, the blocking may include blocking personal network access information of the user that is stored on the memory until the successful comparison of biometric data to biometric information.

In some embodiments, the deactivating may include stopping the blocking of network access information upon the comparing revealing a match of the received biometric data to the stored biometric information.

In some embodiments, the method may include executing network access procedures in response to a request from a network.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic depiction of a device connected to a computer in accordance with an embodiment of the invention;

FIG. 2 is a schematic depiction of components of a device in accordance with a preferred embodiment of the present invention; and

FIG. 3 is a flow diagram of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention. In some embodiments, one or more of the functions described in for example a method of the invention may be contained in a single device, while in other embodiments, one or more of such components may be stored or executed from more than one device.

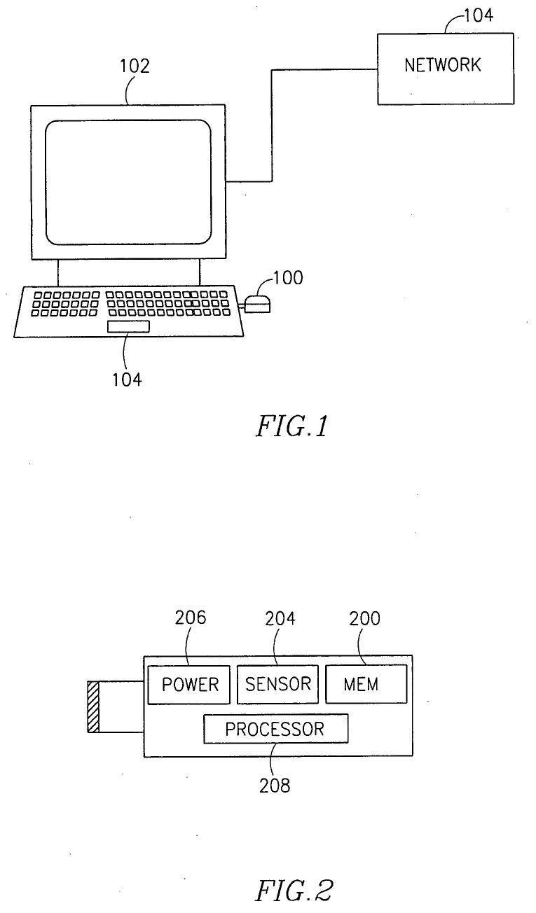

Reference is made to FIG. 1, a schematic depiction of a device connected to a computer in accordance with an embodiment of the invention. In some embodiments, a device 100 may be or include for example a portable memory device such as for example a memory stick, disk on key, hand-held memory or device or other electronic device. In some embodiments, device 100 may be connected with, attached to or plugged into for example a computer 102 such as for example a laptop or desktop computer by way for example a USB interface or by way of for example a wireless link, such as for example infra-red or using a Bluetooth protocol. In some embodiments, device 100 may be included in for example a hand-held computerized device such as for example an email message unit, a cellular phone, a smart card or other device that may include a memory. Other shapes and configurations are possible.

In some embodiments, computer 102 may be or include a communication system for linking computer 102 with a remote network 106.

In some embodiments, one or more of computer 102 and device 100 may include a biometric sensor 104, that may collect biometric data from for example a user. In some embodiments, biometric data may be or include for example voice recognition data, fingerprint data, signature or writing sample data, eye or iris pattern data or other biometric data that may for example be inputted by or collected from a user.

Reference is made to FIG. 2, a schematic depiction of components of a device in accordance with a preferred embodiment of the present invention. In some embodiments, device 100 may include for example a memory unit 200, a sensor such as for example a biometric sensor 204, a power source 206, and a processor 208. In some embodiments one or more of the sensor 204, power source 206 and processor 208 may not be present or may be included in other components that may be part of or not part of device 100.

In operation, a user or other operator may store on memory 200 personal network access information such as for example one or more passwords, authentication codes, VPN settings or other access data that may be required for gaining access to for example network 104. Such personal network access information may be stored on memory 200 so that such information is locked, encrypted or otherwise not accessible other than upon the satisfaction of certain conditions. Memory 200 may also store one or more network access procedures such as sign on procedures, or password input procedures that may recognize a request by network 104 for a user or access-seeker to fill in a form such as a log-on form, or to answer a question or provide information such as log-on information or passwords. Memory 200 or another segment of memory 200 may also store biometric information about a user or other individual who is authorized to use device 100 or to gain access to network 104. A user may submit biometric data to sensor 204, and if such data matches or successfully compares to the biometric information stored in memory 200, device 100 may unlock or decode a password, code or other personal access data that may be required for gaining access to network 104. Device 100 may also activate or unlock network access procedures that may be stored in memory 200. Upon submission of a query or request from network 104, device 100 may provide the access information and provide the one or more responses to queries from network 104 to gain access. Device 100 may in some embodiments, enable a user to gain access to network 104 or to a resource in network 104 through providing biometric data, and without the need for the user to further input or provide network access data.

In some embodiments, device 100 may alleviate or reduce the need to key-in user access data, and thereby avoid or reduce possible copying or recording of such data by a subsequent user of computer 102. Device 100 may also alleviate or reduce the need for a user to remember or record on paper user access data where it may be subject to being forgotten, lost or stolen.

In some embodiments, memory 200 may be or include for example flash memory or other non-volatile memory. In some embodiments, power source may retain stored data on device 100 and may operate or execute stored programs from device 100.

In some embodiments, processor 208 may execute a comparison of biometric information received from sensor 204 with stored biometric data, all from within device 100 so that the stored biometric data need not be uploaded into computer 102, thereby further reducing the possibility of unauthorized copying or intercepting such data. In some embodiments, sensor may be attached to or be part of device 100 so that biometric data need not be entered into computer 102, and so that access to network 204 may be provided from data stored in device 100.

In some embodiments, authentication data may be stored as a HASH or encrypted code. In some embodiments, one or more applications that may be stored on device 100 such as on memory 200 may generate one or more cryptographic keys, such as for example RSA™ key pairs using symmetric or asymmetric methods as well as for user authentication using PKI technology, public key data. In some embodiments, cryptographic software that may operate on device 100 may encrypt one or more of files, folder, disks or partitions, and may create for example virtual drives, and may mount or dismount such drives. In some embodiments, device 100 may send an encrypted file using a public key of a user along with for example an email address or other contact data of the user.

In some embodiments, device 100 may use a microphone as a biometric sound sensor and may collect or compare sounds received over a voice or IP link.

In some embodiments, device 100 or memory 200 may store data that is needed or used in executing a financial transaction, such as for example an address, credit card number, etc. Access to such data as stored on device 100 may be blocked until matching biometric data is received. Software stored in an applications module of device 100 may load such stored data onto for example a web or windows-based form that may call for such information as part of an authentication process.

In some embodiments, device 100 may for example be plugged into a computer 102, and device 100 may prompt a user to input biometric data. Processor 208, or some other processor may compare the received data to stored biometric information. If the comparison is successful, an authentication module that may be stored in memory 200 may launch a password management application within memory 200 that may grant access to a stored password or authentication code. An application module may also launch a sign-on program that may complete a sign-on process to network 104, by for example filling out forms or responding to other prompts of a network authentication process.

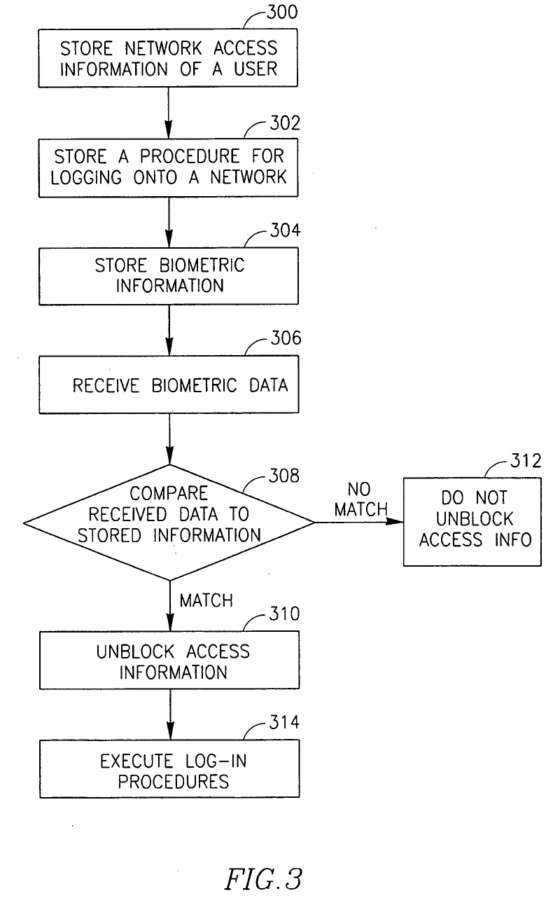

Reference is made to FIG. 3, a flow diagram of a method in accordance with an embodiment of the invention. In some embodiments, and as indicated in block 300, a method may include storing network access information of a user on a memory. In some embodiments, such stored information may be blocked or inaccessible other than upon the satisfaction of certain conditions, some of which may relate to the receipt of matching biometric data. In some embodiments, a memory may be partitioned into two or more parts or segments, and a segment that stores passwords or personalized access information may be blocked or opened upon the occurrence of certain conditions.

In block 302, embodiments of the method may include storing one or more procedures or responses to inquiries for logging on or gaining access to a network connection or to a network resource.

In block 304, embodiments of the method may include storing biometric information of a user on a memory.

In block 306, embodiments of the method may include receiving biometric data from a user and comparing such received data to the stored biometric information.

In block 308, the received biometric data may be compared to the stored biometric data. If such data matches such stored biometric information, the method may proceed to block 310. If such data does not match the stored biometric information, then the method may proceed to block 312.

In block 312, the stored network access information and network log-in procedures may remain blocked and inaccessible.

In block 310, the stored network access information and the log-on procedures may be decoded, unencrypted or otherwise made available from the area or device on which they are stored. In block 314, the stored log-on procedures may be executed and may respond to queries or requests for data from network access procedures.

It will be appreciated by persons skilled in the art that embodiments of the invention are not limited by what has been particularly shown and described hereinabove. Rather the scope of at least one embodiment of the invention is defined by the claims below.

We claim:

1. A device comprising a memory, said memory to
store network access information of a user;
store network access procedures for gaining access to a network by said user; and
store biometric information of said user;
whereupon receipt of biometric data that matches said biometric information, said network access procedure is executed and said network access information is transmitted.

2. The device as in claim 1, comprising a biometric sensor to receive said biometric data.

3. The device as in claim 2, wherein said biometric sensor is selected from the group consisting of a fingerprint reader, a voice sensor, a signature reader and an iris sensor.

4. The device as in claim 1, wherein said memory is to store a blocking code, said blocking code to block access to said network access information, and said blocking code to be deactivated upon receipt of said biometric data.

5. The device as in claim 1, wherein said network access information comprises information to obtain access to a resource on said network.

6. The device as in claim 1, wherein said network access procedure comprises a virtual private network setting.

7. The device as in claim 1, comprising a processor to compare said biometric data to said biometric information and to implement said network access procedure from said device.

8. The device as in claim 1, wherein said network access procedure comprises authorization information for a financial transaction.

9. The device as in claim 1, wherein said network access procedure comprises filling in a field in a log-on form.

10. The device as in claim 1, wherein said memory is to store a public-private key pair and a cryptograph algorithm suitable for decoding of said private key.

11. A method comprising:
storing in a memory personal network access information of a user;
storing in said memory biometric information of said user;
receiving biometric data from said user;
comparing said received biometric data to said stored biometric information; and
transmitting said memory network access information of said user to a network.

12. The method as in claim 11, comprising:
storing in said memory a network access procedure; and
activating said network access procedure following a successful comparing of said received biometric data to said stored biometric data.

13. The method as in claim 11, wherein said receiving comprises receiving biometric data from a biometric sensor selected from the group consisting of a fingerprint reader, a voice recognition sensor, a signature reader and an iris sensor.

14. The method as in claim 11, comprising blocking said personal network access information of said user stored on said memory.

15. The method as in claim 14, comprising deactivating said blocking upon said comparing revealing a match of said received biometric data to said stored biometric information.

16. The method as in claim 11, comprising providing said network access information in response to a request from a network log-on procedure.

17. The method as in claim 11, wherein said transmitting comprises transmitting a virtual private network setting.

18. The method as in claim 11, wherein said transmitting comprises transmitting authorization information for a financial transaction.
